(19) United States
(12) Patent Application Publication
(10) Pub. No.: US 2026/0023401 A1
(43) Pub. Date: Jan. 22, 2026

(54) REGULATOR FOR HEAVY-DUTY VEHICLE TIRE INFLATION SYSTEMS

(71) Applicant: Hendrickson USA, L.L.C., Schaumburg, IL (US)

(72) Inventors: Matt J. Wilson, Canal Fulton, OH (US); Jesse W. Cervantez, Rocky Mount, VA (US); Brett Muckelrath, North Canton, OH (US); Jeffrey S. Morris, Canton, OH (US); Jared A. Haney, East Sparta, OH (US)

(21) Appl. No.: 19/273,290

(22) Filed: Jul. 18, 2025

Related U.S. Application Data
(60) Provisional application No. 63/673,810, filed on Jul. 22, 2024.
(60) Provisional application No. 63/678,158, filed on Aug. 1, 2024.

(51) Int. Cl. G05D 16/10; B60C 29/00

(52) U.S. Cl. CPC G05D 16/103; B60C 29/002

(57) ABSTRACT

A mechanical fluid pressure regulator comprising: a regulator portion for housing a valve assembly, and a manual adjustment portion. The regulator portion having a supply port for receiving a supply pressure and a delivery port for providing a delivery pressure; the delivery port being in selective fluid communication with the supply port. The adjustment portion having a structure at least partially disposed therein. The structure is adjustable for establishing the delivery pressure at a set target and comprises a locking mechanism. The locking mechanism generating prevailing torque to prevent unintentional adjustment of the structure.

### CROSS-REFERENCE TO RELATED APPLICATION

This application claims the benefit of U.S. Provisional Patent Application Nos. 63/673,810, filed Jul. 22, 2024, and 63/678,158, filed Aug. 1, 2024.

### BACKGROUND OF THE INVENTION

### Field of the Invention

The present invention relates generally to tire inflation systems for heavy-duty vehicles. In particular the present invention relates to tire inflation systems for heavy-duty vehicles incorporating fluid pressure regulators. More particularly, the present invention relates to a mechanical regulator for heavy-duty vehicle tire inflation systems, the regulator having a locking mechanism integrated into the bonnet or spring seat of the regulator to provide accurate selection and retention of a target pressure for the tires of the heavy-duty vehicle, thereby minimizing or eliminating drift of the target pressure during operation.

### Background Art

The use of tire inflation systems in heavy-duty vehicles is well-known. For the purposes of clarity and convenience, reference is made to a heavy-duty vehicle with the understanding that such reference includes trucks, tractor-trailers or semi-trailers, trailers, and the like. A heavy-duty vehicle typically includes multiple tires requiring inflation with air to target pressures for optimal performance. The relatively large number of tires on any given heavy-duty vehicle configuration makes it difficult to manually check and maintain the optimal tire pressure for each and every tire. This difficulty is compounded by the fact that heavy-duty vehicles in a fleet may be located at a site for an extended period of time, during which the tire pressure might not be checked. Any one of these heavy-duty vehicles might be placed into service at a moment's notice, leading to the possibility of operation with under- or over-inflated tires. Operating heavy-duty vehicles with under-inflated tires may adversely affect the performance and service-life of the tires, potentially resulting in damage to and/or failure of the tires.

Tire inflation systems have been developed to maintain the tires of heavy-duty vehicles at a target pressure. Tire inflation systems typically operate by inflating tires with air from an air supply using a variety of different components, arrangements, and/or methods. For instance, some tire inflation systems have utilized prior art manually-adjustable, mechanical regulators designed to provide a preselected output or delivery pressure to the tires. Such prior art mechanical regulators generally have one or more interconnected or integrally-formed sections. In particular, prior art mechanical regulators typically include a regulator section having a valve assembly that selectively controls fluid flow through the regulator to the tires of the heavy-duty vehicle. Prior art mechanical regulators also typically include a manual operation section that provides an adjustment mechanism, such as an adjustment screw, that interconnects with the valve assembly to specify or set the fluid pressure delivered to the tires of the heavy-duty vehicle.

More particularly, the manual operation section typically includes a bonnet with an opening for receiving the adjustment screw rotatably disposed within the opening. The adjustment screw abuts or engages a platform or spring seat disposed within the bonnet. The spring seat, in turn, engages an upper end of a coiled adjustment spring that extends along the interior of the bonnet, abutting or engaging a diaphragm separating the manual operation section and regulator section. The diaphragm generally engages a portion of the valve assembly within the regulator section, such that flexion of the diaphragm alters operation of the valve assembly. As a result, rotation of the adjustment screw advances or retracts the adjustment screw within the bonnet, altering the working height of the spring. In turn, the spring increases or decreases the force reacting against the spring seat, increasing or decreasing the compression of the spring. In turn, the spring increases or decreases force on the diaphragm, altering the position of the diaphragm, which, in turn, alters the operation of the valve assembly, thereby altering the delivery pressure, and thus the target pressure for the tires of the heavy-duty vehicle.

While satisfactory for their intended purpose, prior art mechanical regulators have limitations, disadvantages, and drawbacks. For instance, as discussed above, prior art mechanical regulators typically utilize the adjustment screw to alter working height of the spring within the bonnet of the manual operation section in order to establish the target pressure for, and thus the delivery pressure to, the tires of the heavy-duty vehicle. However, during operation of the heavy-duty vehicle, prior art mechanical regulators are generally exposed to high vibrations, accelerations, and shocks that generate loads on components of the prior art regulators as the heavy-duty vehicle travels over the roadway. As a result, the bonnet and/or adjustment screw of the prior art regulators may potentially undergo movement, leading to unintentional changes in the working height of the spring within the bonnet, thereby causing the target pressure for the tires of the heavy-duty vehicle to change or drift away from the preselected target pressure. As a result, the tires of the heavy-duty vehicle may be improperly inflated with and/or without load, potentially reducing fuel economy of the heavy-duty vehicle and/or causing uneven wear and/or reducing the service-life of the tires.

Tire inflation systems have utilized various means to attempt to overcome target pressure drift in prior art mechanical regulators. For instance, some prior art regulators utilize a nut, referred to in the art as a jam nut, attached to a portion of the adjustment screw extending out of the bonnet and tightened down onto the bonnet. However, application and tightening of such jam nuts onto the bonnets of prior art regulators may potentially result in unintentional alteration of the target pressure for the tires of the heavy-duty vehicle. Alternatively, prior art regulators have utilized locking knobs, also referred to as push lock knobs, that engage teeth formed on the bonnet of the prior art regulators to prevent rotation of the knobs when the knobs have been depressed. However, the accuracy of such prior art regulators with locking knobs may potentially be limited because, upon depression of the knob, the teeth of the bonnet can “kick” or cause unintentional rotation of the knob in either direction, thereby increasing or decreasing the pressure setting away from the intended target pressure. Other prior art regulators have utilized adhesive patches applied to the threads of the adjustment screw in order to increase the friction between the opening in the bonnet and the adjustment screw. However, such adhesive patches may potentially decrease in effectiveness or wear out during operation of the heavy-duty vehicle such that drift of the selected target pressure may still occur.

Thus, there is a need for a manually-adjustable mechanical regulator that provides accurate selection and retention of a target fluid pressure at which the regulator maintains the tires and that minimizes or eliminates drift of the target pressure caused by unintended movement of the adjustment screw, increasing operation time of the regulator between system resets and preventing operation of the heavy-duty vehicle with under- or over-inflated tires, thereby reducing maintenance and downtime of the tire inflation system while increasing fuel economy of the heavy-duty vehicle and reducing wear on, preventing damage to, and increasing the service-life of the tires.

### SUMMARY OF THE INVENTION

Objectives of the present invention include providing a manually-adjustable, mechanical regulator that has accurate selection and retention of a target fluid pressure.

A further objective of the present invention is to provide a manually-adjustable mechanical regulator that maintains the tires at the target fluid pressure and minimizes or eliminates drift of the target pressure.

Yet another objective of the present invention is to provide a manually-adjustable mechanical regulator that has increased operation time between system resets.

These objectives and advantages are obtained by the mechanical fluid pressure regulator, according to the present invention, the regulator comprising: a regulator portion for housing a valve assembly, and a manual adjustment portion. The regulator portion having a supply port for receiving a supply pressure and a delivery port for providing a delivery pressure; the delivery port being in selective fluid communication with the supply port. The adjustment portion having a structure at least partially disposed therein. The structure is adjustable for establishing the delivery pressure at a set target and comprises a locking mechanism. The locking mechanism generating prevailing torque to prevent unintentional adjustment of the structure.

### BRIEF DESCRIPTION OF THE SEVERAL VIEWS OF THE DRAWINGS

The exemplary embodiments of the present invention, illustrative of the best mode in which Applicant has contemplated applying the principles, are set forth in the following description, shown in the drawings, and particularly and distinctly pointed out and set forth in the appended claims.

FIG. 1 is an elevational view, partially in section and partially in ghost, of an exemplary embodiment mechanical regulator, according to the present invention, showing the regulator in the balanced condition;

FIG. 2 is an elevational view, partially in section and partially in ghost, of the exemplary embodiment mechanical regulator shown in FIG. 1, showing the regulator in the supply condition;

FIG. 3 is an elevational view, partially in section and partially in ghost, of the exemplary embodiment mechanical regulator shown in FIGS. 1-2, showing the regulator in the exhaust condition;

FIG. 4 is an elevational view, partially in section and partially in ghost, of the bonnet of the exemplary embodiment regulator shown in FIGS. 1-3;

FIG. 5 is an elevational view of the bonnet of the exemplary embodiment regulator shown in FIGS. 1-4, looking axially into the chamber of the bonnet;

FIG. 6 is an elevational view, partially in section and partially in ghost, of another exemplary embodiment mechanical regulator, according to the present invention;

FIG. 7 is an elevational view, in section, of the spring seat of the exemplary embodiment regulator shown in FIG. 6;

FIG. 8 is an elevational view of the spring seat of the exemplary embodiment regulator shown in FIGS. 6-7, looking axially onto the bottom of the spring seat;

FIG. 9 is an elevational view, partially in section and partially in ghost, of yet another exemplary embodiment mechanical regulator, according to the present invention;

FIG. 10 is an elevational view of the bonnet of the exemplary embodiment regulator shown in FIG. 10, looking onto the top of the bonnet;

FIG. 11A is a perspective view of a fastener of an alternate configuration of the exemplary embodiment regulators shown in FIGS. 1-4 and 10, showing stamps formed into the side of the fastener;

FIG. 11B is an elevational view of a different fastener of an alternate configuration of the exemplary embodiment regulators shown in FIGS. 1-4 and 10, showing stamps formed into the top of the fastener;

FIG. 12A is an elevational view of a fastener of another alternate configuration of the exemplary embodiment regulators shown in FIGS. 1-4 and 10; and

FIG. 12B is an elevational view of a different fastener of the other alternate configuration of the exemplary embodiment regulators shown in FIGS. 1-4 and 10.

Similar reference characters refer to similar parts throughout.

### DESCRIPTION OF THE PREFERRED EMBODIMENT

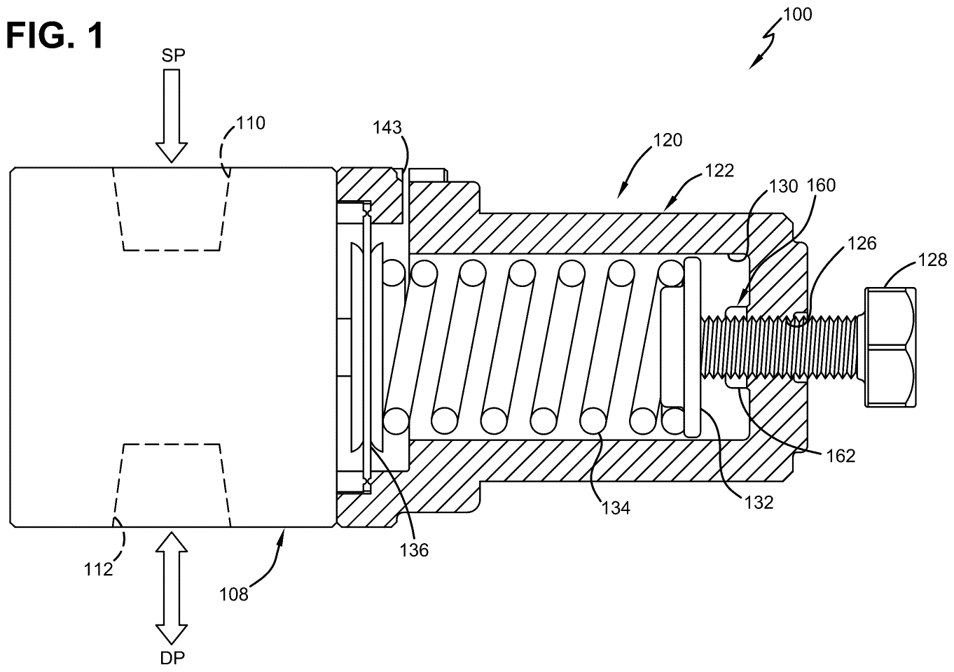

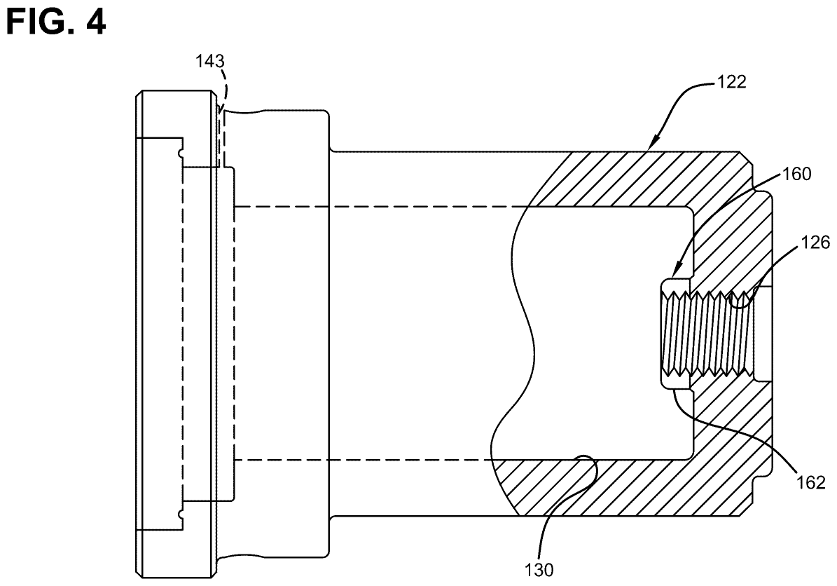

An exemplary embodiment manually-adjustable, mechanical regulator 100 (FIGS. 1-5), according to the present invention, may be incorporated into any suitable tire inflation system (not shown) having a source of fluid pressure (not shown), such as compressed air or nitrogen that may be stored in a pressure vessel or reservoir or supplied by a compressor, as is known. The source of fluid pressure may provide fluid flow or a supply pressure SP to regulator 100.

Regulator 100 may establish and output fluid flow or an output or delivery pressure DP, selectively controlling the flow of fluid pressure to a tire and wheel assembly (not shown) of a heavy-duty vehicle (not shown). Regulator 100 may be formed as a multi-stage or multi-section relieving regulator having a regulator section 108 and a manual operation section 120. Regulator section 108 may include an upper, open-end portion, to which manual operation section 120 may be attached by any suitable means, such as a threaded connection. Regulator section 108 and manual operation section 120 may have respective cylindrical inner surface portions defining respective cavities that may generally be arranged coaxially. It is also contemplated that regulator section 108 and manual operation section 120 could be formed as a single component. A regulator diaphragm 136, formed from any suitable flexible material or materials, such as elastomer, may be disposed between and separate regulator section 108 from manual operation section 120. It is also contemplated that a piston may be utilized in place of diaphragm 136.

Regulator section 108 may include a supply port 110 in fluid communication with the source of fluid pressure, providing supply pressure SP to the supply port. Regulator section 108 may also include an outlet or delivery port 112 in fluid communication with the tire and wheel assembly. A valve arrangement or assembly (not shown) may be supported within regulator section 108, as is known, between supply port 110 and delivery port 112. The valve assembly may be of any suitable type, such as poppet or the like, and may selectively allow or block fluid communication between supply port 110 and delivery port 112, as is known. The valve assembly may also include a component, such as an exhaust portion (not shown) of a poppet, that selectively allows or blocks fluid communication between delivery port 112 and components of manual operation section 120, as described below.

In accordance with an important aspect of the present invention, manual operation section 120 of regulator 100 may include structure for selecting or adjusting the target pressure for the tire and wheel assembly of the heavy-duty vehicle and structure for engaging and/or controlling the valve assembly housed within regulator section 108. In particular, manual operation section 120 may include a bonnet 122 formed from any suitable material, such as metal or composite, but more preferably from zinc or zinc alloy. Bonnet 122 may be formed with one or more exhaust vents 143 (only one shown) formed through a side of the bonnet to equalize pressure between an internal chamber 130 of the bonnet and the external environment as well as to allow the relieving of delivery pressure DP as described below. Bonnet 122 may include a threaded opening 126 for threadably receiving an adjustment screw 128 rotatably disposed through the opening and extending into chamber 130. Adjustment screw 128 may be integrally formed with or abut a platform, piston, or spring seat 132 disposed within chamber 130 adjacent an end of the adjustment screw. Spring seat 132 may engage or abut an upper end of a coiled adjustment spring 134 extending axially along at least a portion of chamber 130. Spring 134 may provide any suitable compression or spring force, as is known. A lower end of spring 134 axially opposite spring seat 132 may be in contact with or engage the upper surface of diaphragm 136. In addition, the lower surface of diaphragm 136 may engage the component of, or otherwise control the position of, the valve assembly and condition of regulator section 108.

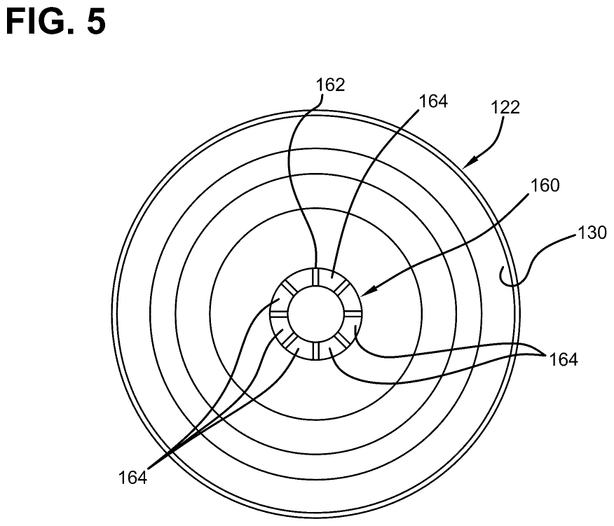

In accordance with another important aspect of the present invention, bonnet 122 may include a locking mechanism 160. In particular, locking mechanism 160 may be integrally formed about opening 126 of bonnet 122 and extend axially into chamber 130 to provide frictional load to the threads of adjustment screw 128 to prevent drift of the pre-selected target pressure. More particularly, locking mechanism 160 may be formed as a sectioned or segmented, threaded collar 162 concentrically about and extending radially inward from opening 126 and axially from bonnet 122 into chamber 130. Collar 162 may be formed with threading tapered relative to opening 126 and may be comprised of a plurality of threaded projections 164 (FIG. 5) arranged in a spaced-apart manner that may give the collar a castellated formation. Collar 162 may have any suitable number of projections 164. As adjustment screw 128 is threaded through opening 126 and into locking mechanism 160, each of projections 164 flex away from the threads of the adjustment screw, cooperating with the tapered threading to increase the friction between collar 162 and the threads of the adjustment screw such that the load on the threads may correspond to and be controllable by the amount of taper and the spring force generated by the projections, thereby generating prevailing torque and preventing unintentional rotation of the adjustment screw. It is also contemplated that opening 126 of bonnet 122 could be formed with any appropriate shape or concentric recess, such as hexagonal, square, triangular, or the like, for receiving a correspondingly-shaped fastener component such that a flex lock nut could be attached into the bonnet using any suitable means, such as press fit.

Rotation of adjustment screw 128 may alter the working height of spring 134, increasing or decreasing the force reacting against spring seat 132, attempting to move or compress the spring downwardly or relax the spring, which, in turn, increases or decreases force applied downwardly against diaphragm 136. The position of diaphragm 136 established by adjustment screw 128, spring seat 132, and spring 134 of regulator 100 in turn establishes delivery pressure DP provided to, and thus the target fluid pressure within, the tire and wheel assembly. More specifically, downward force of spring 134 acting on diaphragm 136 urges or deflects the diaphragm in a downward direction against a force generated by delivery pressure DP. Because diaphragm 136 abuts or engages with a component of the valve assembly within regulator section 108, downward movement of the diaphragm opens and alters the response of the valve assembly, and thus the regulator section, to delivery pressure DP, such that the more the diaphragm is deflected downwardly the greater the fluid flow through the regulator section and the greater delivery pressure DP must be to oppose the diaphragm. Thus, delivery pressure DP, and the target pressure in the tire and wheel assembly, is increased. The target fluid pressure may typically be a value corresponding to a suitable operational pressure for the tire and wheel assembly for loaded or unloaded conditions of the heavy-duty vehicle, such as from about 70 psi to about 125 psi, more preferably from about 105 psi to about 125 psi. Because adjustment screw 128 passes through and engages locking mechanism 160, drift of the preselected target pressure due to vibrations, accelerations, and shocks is minimized or eliminated.

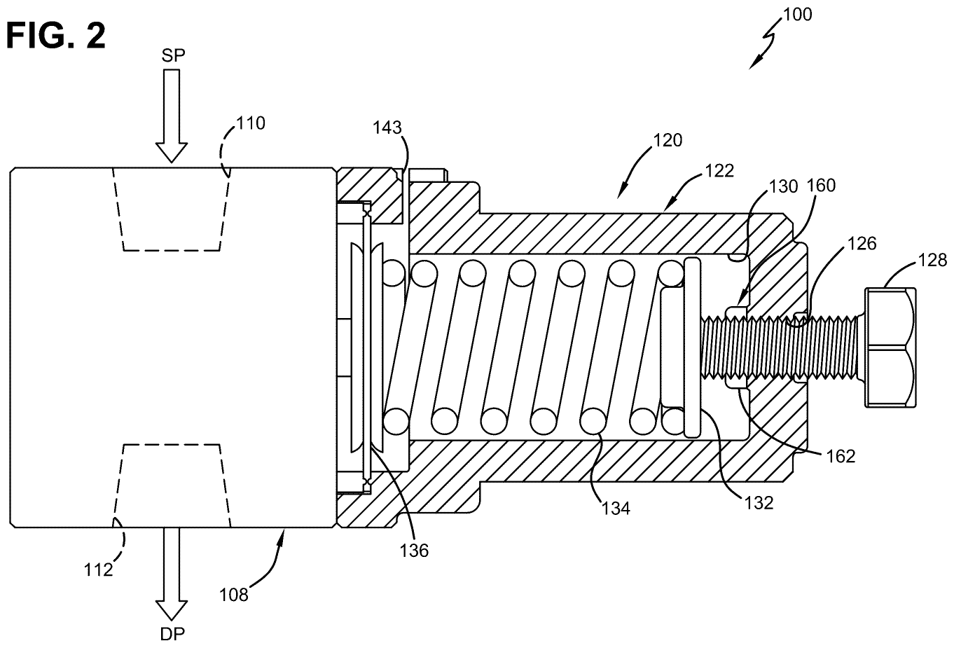

With particular reference to FIGS. 1-3, regulator 100 may have various operating conditions. In a fill or supply state or condition of regulator 100, as shown in FIG. 2, fluid flow, the magnitude and direction of which are indicated by arrows, occurs from supply port 110 through the valve assembly housed within regulator section 108 and out of delivery port 112 to inflate the tire and wheel assembly. The supply condition of regulator 100 generally occurs when the fluid pressure in the tire and wheel assembly, and thus delivery pressure DP at delivery port 112, is less than the pre-selected target pressure set by adjustment screw 128, such as when the heavy-duty vehicle has been parked for an extended period of time. Where fluid pressure in the tire and wheel assembly, and thus delivery pressure DP, is less than the target pressure set by adjustment screw 128, regulator diaphragm 136 will be deflected downwardly by the force of the adjustment screw and spring 134 acting on the diaphragm. Regulator diaphragm 136, in turn, will exert a force on a component of the valve assembly within regulator section 108, such that the regulator section provides fluid flow from supply port 110 to delivery port 112. Regulator section 108 will continue to provide fluid flow from supply port 110 to delivery port 112 until fluid pressure in the tire and wheel assembly achieves the pre-selected target pressure and delivery pressure DP balances the force from adjustment screw 128, spring seat 132, and spring 134 acting on regulator diaphragm 136. At that time, regulator diaphragm 136 will move upwardly, returning to a non-bowed, or balanced, position such that regulator section 108 blocks fluid flow from supply port 110 to delivery port 112, thereby placing regulator 100 in a balanced state or condition.

In the balanced condition of regulator 100, as shown in FIG. 1, no fluid flow occurs from supply port 110 through the valve assembly and out of delivery port 112 or from the delivery port to exhaust vents 143. The balanced condition of regulator 100 generally occurs when the pressure in the tire and wheel assembly is at or slightly above the pre-selected target pressure set by adjustment screw 128, such that there is no demand for fluid flow and fluid delivery pressure DP from delivery port 112 to the tire and wheel assembly. In the balanced condition, delivery pressure DP may act on regulator diaphragm 136, attempting to move the diaphragm upwardly, which would also affect a component of the valve assembly housed within regulator section 108, and thus the response of the regulator section to the delivery pressure. However, in the balanced condition of regulator 100, the force generated by delivery pressure DP against regulator diaphragm 136 is counteracted by the sum of forces generated by components within manual operation section 120. In particular, the rotational position of adjustment screw 128 within opening 126 of bonnet 122 of manual operation section 120 generates a force acting on or compressing spring 134 through spring seat 132. Spring 134, in turn, may act on regulator diaphragm 136, attempting to move the diaphragm downwardly. In the balanced condition, the force of adjustment screw 128, spring seat 132, and spring 134 acting against regulator diaphragm 136 cancels the force generated by delivery pressure DP acting upwardly against the diaphragm, thereby preventing regulator section 108 from providing fluid communication between supply port 110 and delivery port 112 as well as between the delivery port and exhaust vents 143.

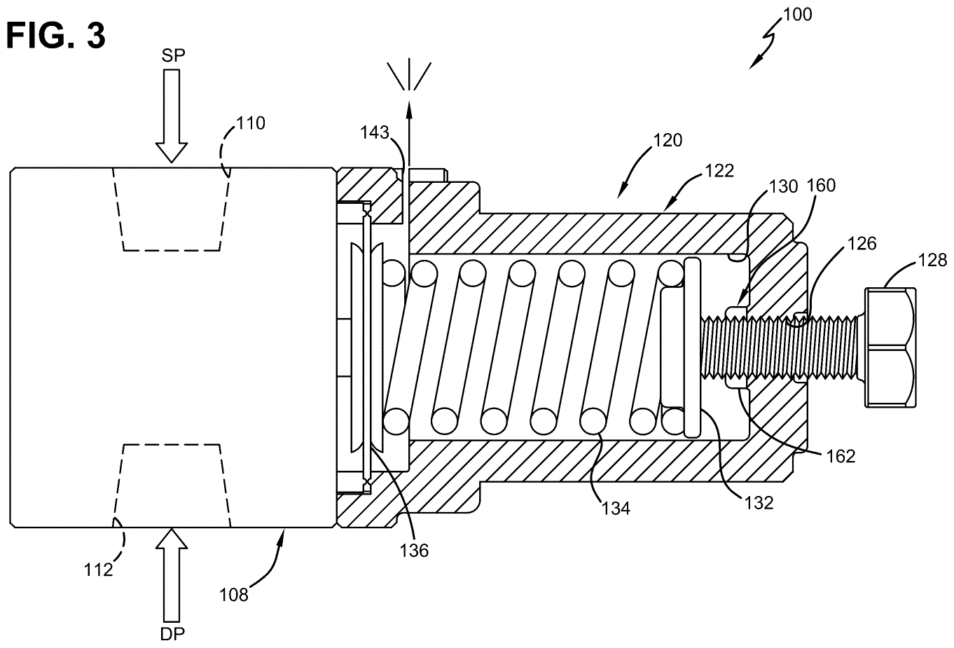

Regulator 100 may also have an exhaust state or condition, as shown in FIG. 3. In the exhaust condition, fluid flow occurs from the tire and wheel assembly through delivery port 112 and regulator section 108 out of exhaust vents 143, reducing delivery pressure DP, and thus the fluid pressure in the tire and wheel assembly. The exhaust condition of regulator 100 generally occurs when the fluid pressure in the tire and wheel assembly, and thus delivery pressure DP at delivery port 112, is greater than the pre-selected target pressure set by adjustment screw 128, such as when the tire and wheel assembly becomes heated during operation of the heavy-duty vehicle, increasing fluid pressure within the tire and wheel assembly. In the exhaust condition, delivery pressure DP generates a force acting upwardly against regulator diaphragm 136 and overcomes the force established by adjustment screw 128, spring seat 132, and spring 134, deflecting the diaphragm upwardly. Upward deflection of diaphragm 136 causes the valve assembly within regulator section 108 to open, providing fluid flow from delivery port 112 past regulator diaphragm 136, exiting regulator 100 through exhaust vents 143. Regulator section 108 will continue to provide fluid flow between delivery port 112 and exhaust vents 143 until the force generated by delivery pressure DP acting against diaphragm 136 is in balance with the force generated by adjustment screw 128, spring seat 132, and spring 134 acting downwardly on the diaphragm.

Thus, exemplary embodiment mechanical regulator 100, according to the present invention, includes bonnet 122 that cooperates with adjustment screw 128 to provide accurate selection of a target fluid pressure at which the regulator is able to maintain the tire and wheel assembly. In addition, bonnet 122 includes locking mechanism 160 that minimizes or eliminates drift of the target pressure to increase operation time of regulator 100 between system resets and prevent operation of the heavy-duty vehicle with under- or over-inflated tires, reducing maintenance and downtime of the tire inflation system while increasing fuel economy of the heavy-duty vehicle and reducing wear on, preventing damage to, and increasing the service-life of the tire and wheel assembly.

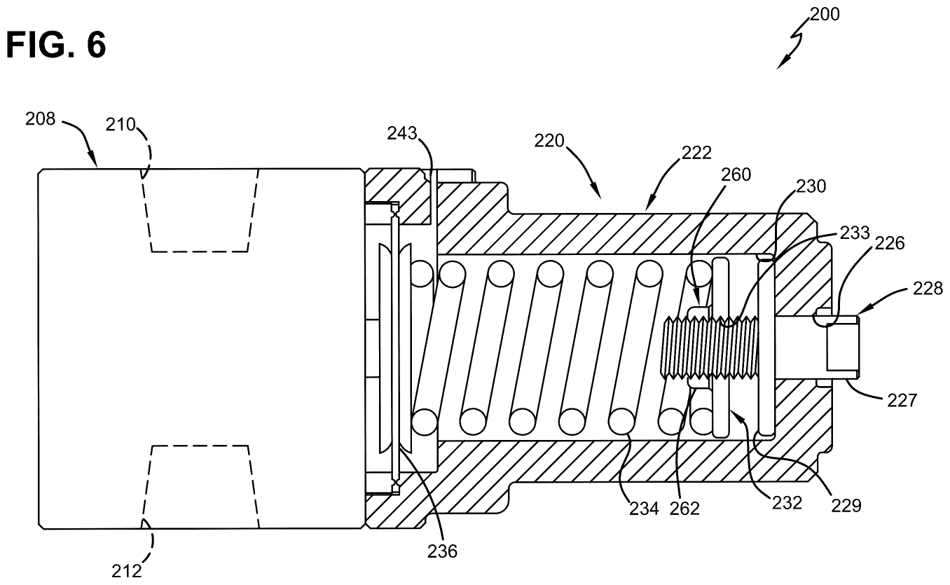

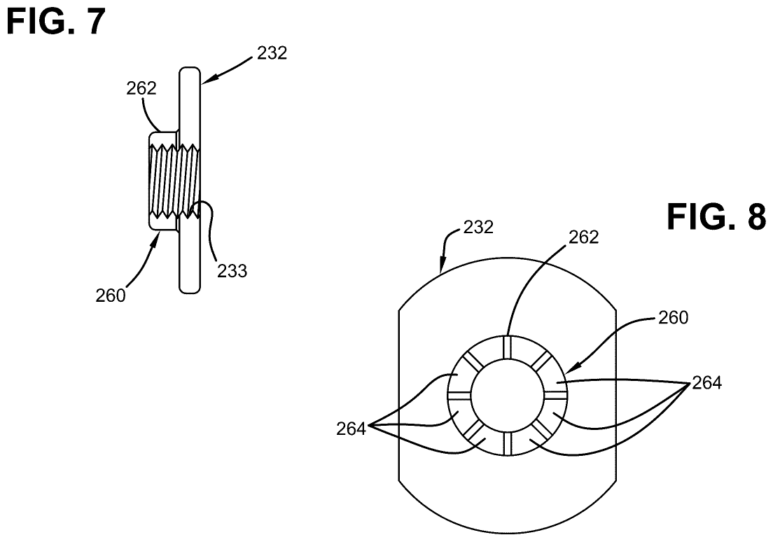

Another exemplary embodiment mechanical regulator 200 (FIGS. 6-8), according to the present invention may be incorporated into any suitable tire inflation system (not shown) having a source of fluid pressure (not shown). Regulator 200 may be similar in structure, arrangement, and operation to regulator 100, described above and shown in FIGS. 1-5. As such the description below will be directed to the differences between regulator 100 and regulator 200.

In particular, regulator 200 may include manual operation section 220 with a bonnet 222. Bonnet 222 may be formed from any suitable material, such as metal or composite, but more preferably from zinc or zinc alloy. Bonnet 222 may be formed with one or more exhaust vents 243 (only one shown) formed through a side of the bonnet to equalize pressure between an internal chamber 230 of the bonnet and the external environment as well as allow the relieving of delivery pressure DP in a fashion similar to that described above. Bonnet 222 may include an opening 226 for receiving a head 227 of an adjustment screw 228 rotatably disposed through the opening. Adjustment screw 228 may also be formed with an integral flange 229 extending radially outward from the adjustment screw adjacent head 227 and in contact with or abutting the inside of bonnet 222 about opening 226, preventing removal of the adjustment screw through the opening.

In accordance with an important aspect of the present invention, adjustment screw 228 may engage a platform or spring seat 232 formed with an integral locking mechanism 260 and disposed within chamber 230. In particular, locking mechanism 260 may be integrally-formed about a threaded opening 233 formed through spring seat 232 and extend axially toward a coiled adjustment spring 234 abutting or engaging the spring seat. Locking mechanism 260 provides frictional load to the threads of adjustment screw 228 to prevent drift of the pre-selected target pressure. More particularly, locking mechanism 260 may be formed as a sectioned or segmented, threaded collar 262 concentrically about and extending radially inward from opening 233 and axially from spring seat 232 toward spring 234. Collar 262 may be comprised of a plurality of threaded projections 264 (FIG. 8) arranged in a manner that give the collar a castellated formation. As adjustment screw 228 is threaded through opening 233 and into locking mechanism 260, each of projections 264 flex away from the threads of the adjustment screw, increasing the friction between collar 262 and the threads of the adjustment screw, thereby generating prevailing torque and preventing unintentional rotation of the adjustment screw. Spring seat 232 may engage or abut the upper end of adjustment spring 234 extending axially along at least a portion of chamber 230. Spring 234 may provide any suitable compression or spring force, as is known. A lower end of spring 234 axially opposite spring seat 232 may be in contact with or engage the upper surface of a regulator diaphragm 236 separating mechanical operation section 220 from a regulator section 208 of regulator 200. In addition, the lower surface of diaphragm 236 may engage a component of, or otherwise control the position of a valve assembly disposed within regulator section 208, and thus the condition of the regulator section.

Rotation of adjustment screw 228 may alter the working height of spring 234 by drawing or pushing spring seat 232 toward or away from flange 229 along the adjustment screw, decreasing or increasing the force, respectively, reacting against spring seat 232 and attempting to relieve or compress the spring downwardly, which, in turn, decreases or increases force acting downwardly against diaphragm 236. The position of diaphragm 236 established by adjustment screw 228, spring seat 232, and spring 234 establishes delivery pressure DP that regulator 200 may provide to, and thus the target fluid pressure within, the tire and wheel assembly in a manner similar to diaphragm 136 of regulator 100 discussed above. More specifically, downward force of spring 234 acting on diaphragm 236 urges or deflects the diaphragm in a downward direction against a force generated by delivery pressure DP. Because diaphragm 236 abuts or engages with a component of the valve assembly within regulator section 208, downward movement of the diaphragm opens the valve assembly and alters the response of the regulator section to delivery pressure DP, such that the more the diaphragm is deflected downwardly the greater the fluid flow through the valve assembly and the greater delivery pressure DP must be to oppose the diaphragm. Thus, delivery pressure DP, and the target pressure within the tire and wheel assembly, is increased. Because adjustment screw 228 passes through opening 233 of spring seat 232 and engages locking mechanism 260, drift of the preselected target pressure due to road load vibrations, accelerations, and/or shocks is minimized or eliminated.

Regulator 200 may have balanced, supply, and exhaust conditions that operate similar to those of regulator 100, described above. Just as with regulator 100, regulator 200 may be in the balanced state or condition when the fluid pressure in the tire and wheel assembly, and thus delivery pressure DP at a delivery port 212 of regulator section 208, is at or slightly above the pre-selected target pressure set by adjustment screw 228, such that there is no demand for fluid flow from a supply port 210 through the valve assembly and delivery port 212 to the tire and wheel assembly. Similarly, regulator 200 may be in a supply state or condition when the fluid pressure in the tire and wheel assembly, and thus delivery pressure DP at delivery port 212, is less than the pre-selected target pressure set by adjustment screw 228, such as when the heavy-duty vehicle has been parked for an extended period of time. And, as with regulator 100, regulator 200 may be in the exhaust condition when the fluid pressure in the tire and wheel assembly, and thus delivery pressure DP at delivery port 212, is greater than the pre-selected target pressure set by adjustment screw 228, such as when the tire and wheel assembly becomes heated during operation of the heavy-duty vehicle, increasing fluid pressure within the tire and wheel assembly.

Thus, exemplary embodiment mechanical regulator 200, according to the present invention, includes bonnet 222 that cooperates with adjustment screw 228 and spring seat 232 to provide accurate selection of a target fluid pressure at which the regulator is able to maintain the tire and wheel assembly. In addition, spring seat 232 includes locking mechanism 260 that minimizes or eliminates drift of the target pressure to increase operation time of the regulator between system resets and prevent operation of the heavy-duty vehicle with under- or over-inflated tires, reducing maintenance and downtime of the tire inflation system while increasing fuel economy of the heavy-duty vehicle and reducing wear on, preventing damage to, and increasing the service-life of the tire and wheel assembly.

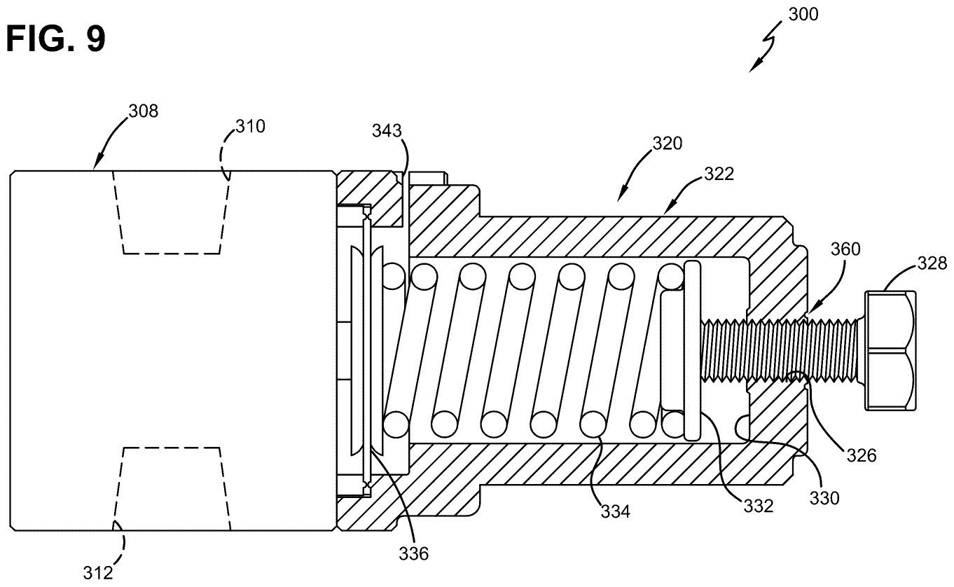

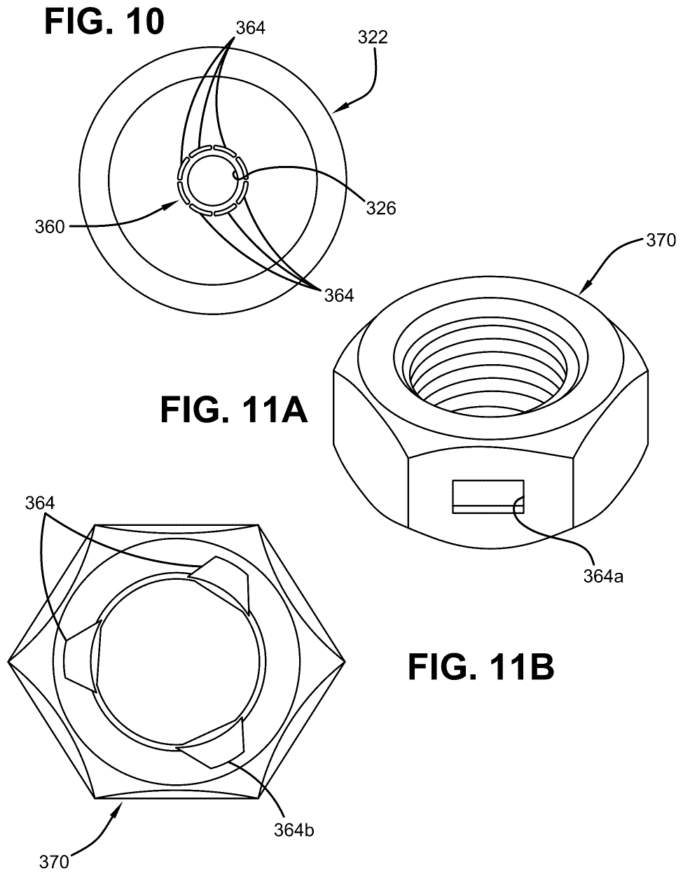

Another exemplary embodiment mechanical regulator 300 (FIGS. 9-10), according to the present invention may be incorporated into any suitable tire inflation system (not shown) having a source of fluid pressure (not shown). Regulator 300 may be similar in structure, arrangement, and operation to regulators 100, 200, described above and shown in FIGS. 1-8. As such the description below will be directed to the differences between regulators 100, 200 and regulator 300.

In particular, regulator 300 may include manual operation section 320 with a bonnet 322. Bonnet 322 may be formed from any suitable material, such as metal or composite, but more preferably from zinc or zinc alloy. Bonnet 322 may be formed with one or more exhaust vents 343 (only one shown) formed through a side of the bonnet to equalize pressure between an internal chamber 330 of the bonnet and the external environment as well as allow the relieving of delivery pressure DP in a fashion similar to that described above. Bonnet 322 may include a threaded opening 326 for receiving an adjustment screw 328 rotatably disposed through the opening. Adjustment screw 328 may be integrally formed with or abut a platform, piston, or spring seat 332 disposed within chamber 330 adjacent an end of the adjustment screw. Spring seat 332 may, in turn, engage or abut an upper end of a coiled adjustment spring 334 extending axially along at least a portion of chamber 330. Spring 334 may provide any suitable compression or spring force, as is known. A lower end of spring 334 axially opposite spring seat 332 may be in contact with or engage the upper surface of diaphragm 336. In addition, the lower surface of diaphragm 336 may engage a component of, or otherwise control the position of, a valve assembly within a regulator section 308 of regulator 300.

In accordance with an important aspect of the present invention, bonnet 322 may include a locking mechanism 360. In particular, locking mechanism 360 may be integrally formed about opening 326 of bonnet 322 to provide frictional load to the threads of adjustment screw 328 to prevent drift of the pre-selected target pressure. More particularly, locking mechanism 360 may be formed as a series of stamps 364 pressed into the top surface of bonnet 322 toward chamber 330 concentrically about opening 326 in a circumferentially spaced-apart manner. Locking mechanism 360 may include any suitable number of stamps 364. Stamps 364 cause distortion of the end thread of threaded opening 326 such that, as adjustment screw 328 is threaded into and through the opening, the distorted thread increases friction between the opening and the threads of the adjustment screw. As a result, the load on the threads of adjustment screw 328 may correspond to and be controllable by the amount of interference caused by the distortion of the end thread of opening 326, thereby generating prevailing torque and preventing unintentional rotation of the adjustment screw.

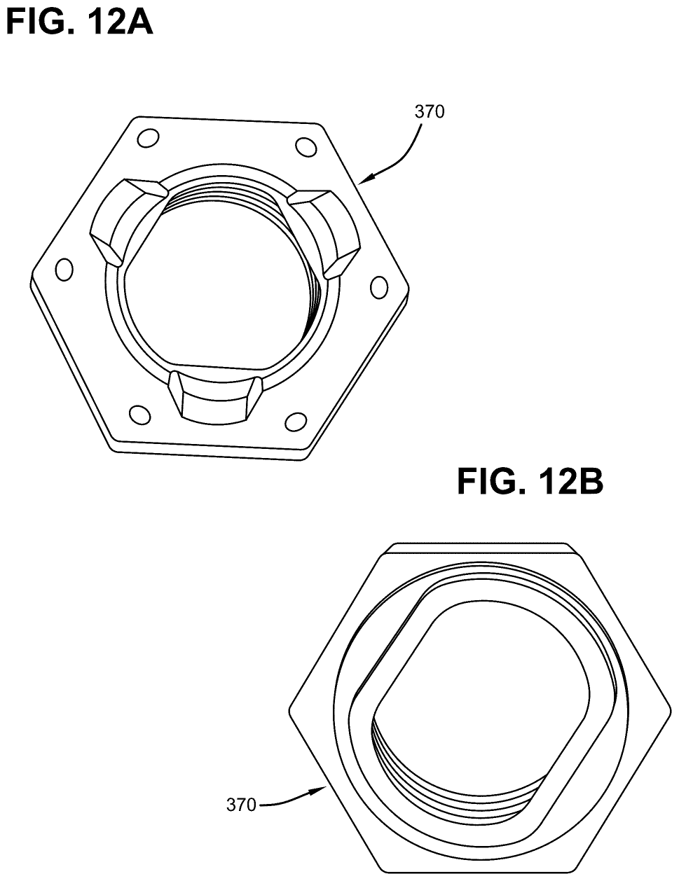

In accordance with another important aspect of the present invention, and with particular reference to FIGS. 11A-12B, it is contemplated that opening 326 of bonnet 322 could be formed with any appropriate shape or concentric recess, such as hexagonal, square, triangular, or the like. In such a configuration, locking mechanism 360 may include a correspondingly-shaped fastener component, such as threaded fastener 370, attached to bonnet 322 or disposed within opening 326 using any suitable means, such as press fit. More particularly, stamps 364b may be formed into the top or bottom surface of fastener 370, as shown in FIG. 11B, to distort one of the end threads of the fastener and create optimal interference between the threads of adjustment screw 328 and the fastener. Alternatively, stamps 364a may be formed into one or more sides of fastener 370, as shown in FIG. 11A, to distort the threads near the mid-point of the fastener. It is also contemplated that fastener 370 could have two or more sides of the fastener distorted, as shown in FIGS. 12A-B, to create, for example, an obround or triangular thread within the fastener and create optimal interference between the threads of adjustment screw 328 and the fastener.

Similar to regulators 100, 200, described above, rotation of adjustment screw 328 may alter the working height of spring 334, increasing or decreasing the force reacting against spring seat 332, attempting to move or compress the spring downwardly or relax the spring, which, in turn, increases or decreases force applied downwardly against diaphragm 336. The position of diaphragm 336 established by adjustment screw 328, spring seat 332, and spring 334 of regulator 300, in turn, establishes delivery pressure DP provided to, and thus the target fluid pressure within, the tire and wheel assembly (not shown). More specifically, downward force of spring 334 acting on diaphragm 336 urges or deflects the diaphragm in a downward direction against a force generated by delivery pressure DP. Because diaphragm 336 abuts or engages with a component of the valve assembly within regulator section 308, downward movement of the diaphragm opens and alters the response of the valve assembly, and thus the regulator section, to delivery pressure DP, such that the more the diaphragm is deflected downwardly the greater the fluid flow through the regulator section and the greater delivery pressure DP must be to oppose the diaphragm. Thus, delivery pressure DP, and the target pressure in the tire and wheel assembly, is increased. The target fluid pressure may typically be a value corresponding to a suitable operational pressure for the tire and wheel assembly for loaded or unloaded conditions of the heavy-duty vehicle, such as from about 70 psi to about 125 psi, more preferably from about 105 psi to about 125 psi. Because adjustment screw 328 passes through and engages locking mechanism 360, drift of the preselected target pressure due to vibrations, accelerations, and shocks is minimized or eliminated.

Regulator 300 may have balanced, supply, and exhaust conditions that operate similar to those of regulators 100, 200, described above. Just as with regulators 100, 200, regulator 300 may be in the balanced state or condition when the fluid pressure in the tire and wheel assembly, and thus delivery pressure DP at a delivery port 312 of regulator section 308, is at or slightly above the pre-selected target pressure set by adjustment screw 328, such that there is no demand for fluid flow from a supply port 310 through the regulator section and delivery port to the tire and wheel assembly. Similarly, regulator 300 may be in a supply state or condition when the fluid pressure in the tire and wheel assembly, and thus delivery pressure DP at delivery port 312, is less than the pre-selected target pressure set by adjustment screw 328, such as when the heavy-duty vehicle has been parked for an extended period of time. And, as with regulators 100, 200, regulator 300 may be in the exhaust condition when the fluid pressure in the tire and wheel assembly, and thus delivery pressure DP at delivery port 312, is greater than the pre-selected target pressure set by adjustment screw 328, such as when the tire and wheel assembly becomes heated during operation of the heavy-duty vehicle, increasing fluid pressure within the tire and wheel assembly.

Thus, exemplary embodiment mechanical regulator 300, according to the present invention, includes bonnet 322 with locking mechanism 360 that cooperates with adjustment screw 328 and spring seat 332 to provide accurate selection of a target fluid pressure at which the regulator is able to maintain the tire and wheel assembly, minimizing or eliminating drift of the target pressure, increasing operation time of the regulator between system resets and preventing operation of the heavy-duty vehicle with under- or over-inflated tires, thereby reducing maintenance and downtime of the tire inflation system while increasing fuel economy of the heavy-duty vehicle and reducing wear on, preventing damage to, and increasing the service-life of the tire and wheel assembly.

It is to be understood that mechanical regulators 100, 200, 300 according to the present invention, may be incorporated into all types of tire inflation systems, including systems utilized on heavy-duty vehicles with single or dual tire configurations and multiple axles, without affecting the concept or operation of the present invention. It is also to be understood that the structure and operation of regulators 100, 200, 300 according to the present invention, may be altered or rearranged, or certain components omitted or added, without affecting the overall concept or operation. For example, pistons may be utilized in place of regulator diaphragms 136, 236, 336 of regulators 100, 200, 300, respectively. In addition, bonnets 122, 322 and/or spring seat 232 may be utilized with any suitable regulator other than those shown and described.

Accordingly, regulators 100, 200, 300 of the present invention are simplified; provide an effective, safe, inexpensive, and efficient structure and method, which achieve all the enumerated objectives; provide for eliminating difficulties encountered with prior art regulators; and solve problems and obtain new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the description and illustrations of the invention are by way of example, and the scope of the invention is not limited to the exact details shown or described.

Having now described the features, discoveries, and principles of the invention; the manner in which the regulators are used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. A mechanical fluid pressure regulator, said regulator comprising:
a regulator section for housing a valve assembly, said regulator section having a supply port for receiving a supply pressure and a delivery port for providing a delivery pressure; said delivery port being in selective fluid communication with said supply port; and
a manual operation section, said operation section having a structure at least partially disposed therein;
wherein said structure is adjustable for establishing said delivery pressure at a set target, said structure including a locking mechanism, said locking mechanism generating prevailing torque to prevent unintentional adjustment of the structure.

2. The mechanical fluid pressure regulator according to claim 1, said structure further comprising an adjustment screw rotatably disposed at least partially through an opening in said regulator; and
a spring seat disposed within the regulator, said spring seat operatively engaging said adjustment screw and a spring;
wherein rotation of the adjustment screw establishes said set target for said delivery pressure.

3. The mechanical fluid pressure regulator according to claim 2, said structure further comprising a flexible diaphragm separating said regulator portion from said manual adjustment portion, said diaphragm operatively engaging said spring;
wherein deflection of said diaphragm affects the response of said regulator portion to said supply pressure and said delivery pressure.

4. The mechanical fluid pressure regulator according to claim 3, said locking mechanism further comprising a threaded collar for threadably receiving said adjustment screw, said threaded collar having tapered threads for engaging the corresponding threads of the adjustment screw.

5. The mechanical fluid pressure regulator according to claim 4, said collar further comprising one or more circumferentially spaced-apart projections, said tapered threads being formed on said one or more projections;
wherein said adjustment screw causes outward deflection of the one or more projections when received by said collar to generate prevailing torque and prevent unintentional rotation of the adjustment screw.

6. The mechanical fluid pressure regulator according to claim 5, said collar being formed concentrically about said opening in said regulator and extending axially into said regulator.

7. The mechanical fluid pressure regulator according to claim 5, said spring seat further comprising a second opening formed through the spring seat, said second opening being threaded for receiving said adjustment screw.

8. The mechanical fluid pressure regulator according to claim 7, said collar being formed concentrically about said second opening through said spring seat and extending axially from the spring seat.

9. The mechanical fluid pressure regulator according to claim 8, said adjustment screw further comprising a flange disposed within said regulator, said flange contacting the inner surface of the regulator to prevent axial movement of the adjustment screw in a direction away from said spring.

10. The mechanical fluid pressure regulator according to claim 3, said locking mechanism further comprising one or more stamps formed into said regulator in a circumferentially-spaced arrangement about said opening to deform the end thread of the opening.

11. The mechanical fluid pressure regulator according to claim 3, said locking mechanism further comprising a fastener fixedly disposed within said opening in said regulator, said fastener threadably receiving said adjustment screw.

12. The mechanical fluid pressure regulator according to claim 11, said fastener further comprising one or more stamps formed into an upper surface of the fastener to deform the end thread of the fastener.

13. The mechanical fluid pressure regulator according to claim 11, said fastener further comprising one or more stamps formed into respective sides of the fastener to deform the middle threads of the fastener.

14. The mechanical fluid pressure regulator according to claim 11, said fastener further comprising a threaded opening formed through the fastener for receiving said adjustment screw, said threaded opening having an obround or triangular shape.
